(19) United States
(12) Patent Application Publication
(10) Pub. No.: US 2015/0261663 A1
(43) Pub. Date: Sep. 17, 2015

(54) METHOD FOR MANAGING THE MEMORY RESOURCES OF A SECURITY DEVICE, SUCH AS A CHIP CARD, AND SECURITY DEVICE IMPLEMENTING SAID METHOD

(71) Applicant: MORPHO, Issy Les Moulineaux (FR)

(72) Inventor: Pascal Dumas, Issy-Les-Moulineaux (FR)

(21) Appl. No.: 14/433,473

(22) PCT Filed: Apr. 14, 2014
(86) PCT No.: PCT/EP2014/057520

§ 371 Date: Apr. 3, 2015

(30) Foreign Application Priority Data
Apr. 16, 2013 (FR) 13/53411

(51) Int. Cl. G06F 12/02

(52) U.S. Cl. CPC G06F 12/023; G06F 2212/1044

(57) ABSTRACT

Managing memory resources of a security device, such as a chip card, may include: formatting memory space allocated to a session for storing computer objects and, carried out whenever a computer object is created; allocating a memory block in the memory space for storing the computer object being created; and partitioning the memory space allocated to a session into in one side a first memory subspace, the first address of which is determined according to a random/pseudorandom number and the last address of which is the allocated memory space's last address, and in another side a second memory subspace the first address of which is the allocated memory space's first address and the last address of which precedes the first subspace's first address. The allocating a memory block may include seeking an allocatable memory block first performed in the first memory subspace and, if necessary, in the second memory subspace.

The present invention relates to a method for managing memory resources of a security device, such as a chip card, that can be led to manipulate confidential data. The present application finds particular interest, for example, in any type of security device, such as a chip card, a bank card, a SIM card, a so-called “embedded SIM card” device, etc., which comprises a processing unit, such as a microcontroller, for manipulating confidential information, said processing unit being provided with an operating system fulfilling in particular the functions of management of the resources of the security device and consequently of its memory resources.

Such a security device, a chip card in particular, has three types of memory: a read only memory (ROM), a random access memory (RAM) and an electrically erasable programmable read only memory (EEPROM). The data that are stored in the ROM memory are definitively stored. These may be programs, such as the operating system of the security device. In the other two memories, the data are temporarily stored. More particularly, the RAM memory is used for data that must be frequently updated but also for temporary data that require a high degree of confidentiality, such as security data, for example cryptographic enciphering data.

Generally, the data that are stored in a memory, whatever the type of the latter, are stored under the form of computer objects. These computer objects may be of various types: they may be applications or data. Each computer object contains a certain number of attributes characterising it and methods corresponding to the processing operations that must be carried out on said object. The operating system of the security device and the current computer programs are designed so as to be able to represent, store and manipulate these objects, and this with the greatest possible security. To this end, they also implement security functions.

Nevertheless, in order to circumvent these security functions, attacks are intended to interfere with the memory, in particular by modifying the sensitive data that are stored therein. In order to protect against such attacks and thus to protect the sensitive data that are stored in memory, hardware and software integrity control mechanisms are generally installed. These may for example be duplication of data, addition of supplementary data or addition of a checksum to the data. However, the main drawback of these mechanisms is that they require additional memory space, whereas the latter is a limited and expensive resource.

The aim of the invention is to solve the problem above addressed and, for this purpose, proposes a method for managing the memory resources of a security device, such as a chip card, of the type comprising the step of formatting a memory space allocated to a session for storing computer objects and carried out whenever a computer object is created, a step of allocating a memory block in said memory space for storing said computer object being created. According to the invention, said method further comprises:

a step of partitioning the memory space allocated to a session into in one side a first memory subspace the first address of which is determined according to a random or pseudorandom number and the last address of which is the last address of said memory space allocated, and in another side a second memory subspace the first address of which is the first address of said allocated memory space and the last address of which is the address preceding the first address of said first subspace,

the step of allocating a memory block comprising a step of searching for an allocatable memory block performed first of all in said first memory subspace and then, if necessary, in said second memory subspace.

The present invention also concerns a security device, such as a chip card, comprising a processing unit provided with an operating system and at least one memory, said security device being characterised in that said operating system is designed to be able to implement the management method set out above.

The present invention also concerns a program implemented on a memory medium of a security device, such as a chip card, which comprises a processing unit provided with an operating system and at least one memory, said program being able to be implemented in said operating system and comprising instructions for implementing a management method according to the one that is disclosed above.

The features of the invention mentioned above, as well as others, will emerge more clearly from the reading of the following description of an example embodiment, said description being given in relation to the accompanying drawings, among which:

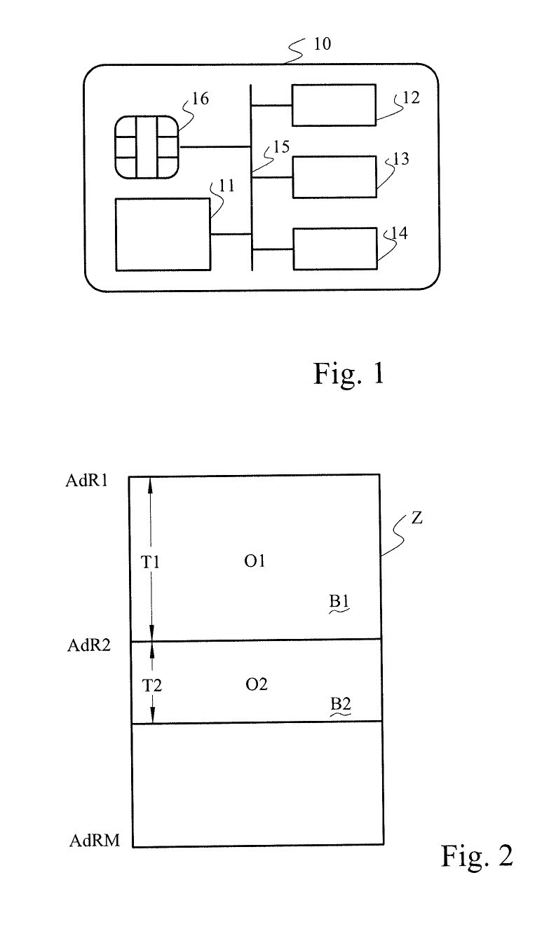

FIG. 1 is a schematic view of a chip card,

FIG. 2 is a view illustrating a method for managing memory resources according to the prior art for allocating memory blocks to computer objects,

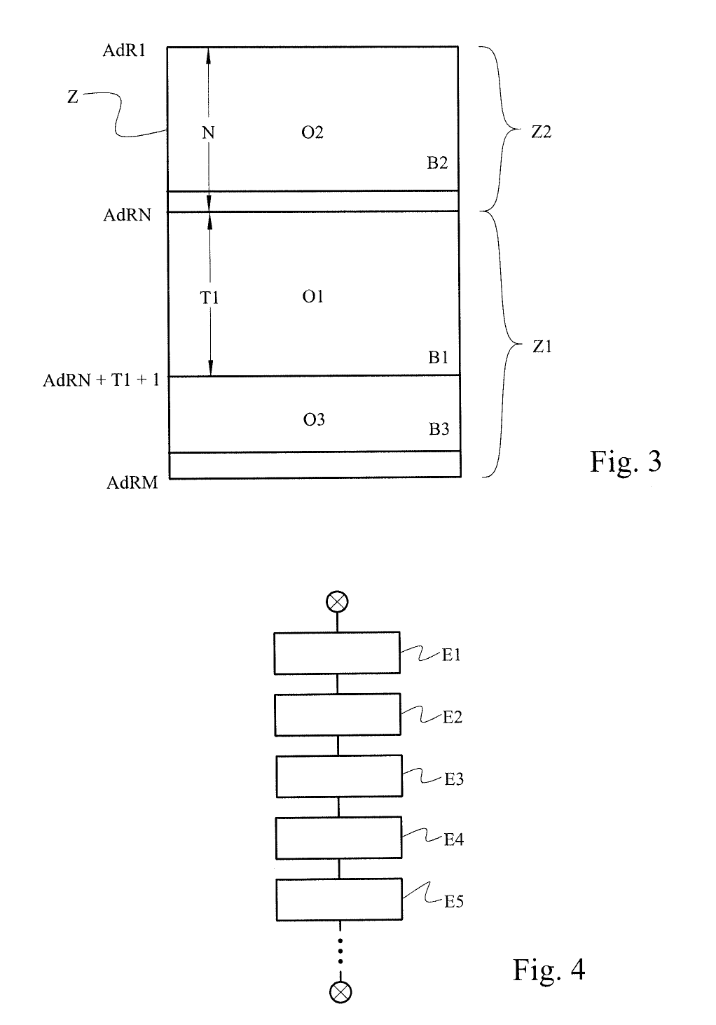

FIG. 3 is a view illustrating a method for managing memory resources according to the invention for allocating memory blocks to computer objects, and

FIG. 4 is a flow diagram of a method for managing memory resources according to the present invention.

In the present invention, security device means a device that is led to manipulate, that is to say write in memory, read from memory, process by means of an algorithm, etc., data, some of which carry confidential information. Among such security devices, chip cards of whatever type can be cited,. The subject matter of the rest of the description is a chip card, but this in no way limits the invention.

The security device that is depicted in FIG. 1 is therefore a chip card that consists of a flat substrate 10 incorporating electronic circuits comprising a processing unit 11, such as a microprocessor or microcontroller, and at least three memories 12 to 14 respectively of the read only memory (ROM), random access memory (RAM) and electrically erasable programmable read only memory (EEPROM) type. The processing unit 11 and the memories 12 to 14 are connected together via a bus 15, to which a connection interface 16 is also connected.

In the ROM memory of the chip card an operating system is recorded that enables the processing unit 11 to manage the various resources present on the card, and in particular the memory resources.

As for the RAM and EEPROM memories, they enable to temporarily store computer objects, which may be of various types: they may be applications or data. Each computer object contains a certain number of attributes characterising said object and methods corresponding to the processing operations that may be performed on said object.

For a more detailed description of a chip card, reference can be made to the standardisation document ISO 7816-3.

The functioning of a chip card is in summary as follows. When this card is introduced into a suitable card reader, the electronic circuits 11 to 14 are powered up and a new session can start. This is for example triggered by a suitable message, also referred to as an APDU (application protocol data unit), transmitted by the reader via the interface 16. This ADPU data unit triggers the selection of a certain number of applications (sometimes referred to as applets) and execution thereof by the processing unit 11. The effect of these applications is to manipulate data and in their turn send ADPU data units in the direction of the reader.

In the present patent, a session is not necessarily defined as all the processes implemented between the introduction of the card into the reader and its removal, but rather as all the processes implemented by a set, said set being defined for example in an APDU data unit transmitted by the reader, of applications executed by the processing unit 11.

When a session is launched, a memory space Z of dimension M is made available by formatting. This memory space Z has the lowest address AdR1 and the highest address AdRM (see FIG. 2).

During such a session, computer objects are created and then deleted both in RAM memory and in EEPROM memory. When a computer object is created (in JAVA, this creation is for example performed by means of the operator new), an allocatable memory block, that is to say an available one, is sought in the memory space Z and is allocated to the object being created. An allocated memory block is essentially characterised by a reference address and a size linked to the size of the object, which in its case depends closely on the attributes and methods that it comprises.

FIG. 2 depicts a memory space Z that has been made available by formatting as well as an object O1 that occupies a memory block B1 defined by its reference address AdR1, corresponding here to the bottom address of the memory area Z, and by its size T1. When the object O2 is created, the reference address AdR2 of the memory block B2 able to accept it is determined. Its size T2 corresponds to that of the object O2.

Once it is used, a computer object has its memory block released for possible other objects.

In order to be able to manipulate them, the sensitive data of a memory card such as the identifiers of the owner of the card, the passwords, etc., are stored in memory, like all data, in the form of computer objects. For security reasons, they will be stored in the most elusive way possible and, to do this, they will generally be stored in RAM memory.

However, it has been remarked that the computer objects thus created are often created at the same reference addresses, in particular for sessions of an identical type (that is to say sessions that select and execute the same applications). This turns out to be a breach for attacks on the chip card, which often use the repetition of the same operation a large number of times.

The present invention seeks to solve this problem.

Like the prior art, when a session is launched, a memory space Z of dimension M is made available by formatting and allocated to the session. Nevertheless, as shown in FIG. 3, the memory space Z allocated to the session is partitioned into a first memory subspace Z1, the first address of which in the memory space Z is AdRN, determined according to a random or pseudorandom number, and the last address of which corresponds to the last address of the memory space Z, that is to say AdRM, and into a second memory subspace Z2, the first address of which is the first address of the memory space Z, that is to say AdR1, and the last address of which corresponds to the address preceding the first address of the first memory subspace, that is to say AdRN-1.

The first address AdRN of the first memory subspace Z1 is for example determined by adding the first address AdR1 of the memory space Z to a random or pseudorandom number N, that is to say:

AdRN=AdR1+N

According to another feature of the invention, when an object Oi is created, a block able to be allocated to said object Oi is first sought in the first memory subspace Z1 and then if necessary in the second memory subspace Z2. This searching step is followed by the allocation itself of a block Bi to said object Oi.

In FIG. 3, the first block B1 able to accept the object O1 is created in the memory subspace Z1, with its reference address corresponding to the address AdRN. The second block B2 able to accept the object O2 has a size T2 greater than the dimension of the free space in the memory subspace Z1. If T1 is the size of the object O1, the dimension of this free space is:

AdRM−(AdRN+T1)

Then the block B2 is created in the memory subspace Z2 with the reference address AdR1.

On the other hand, the block B3 able to accept the object O3 has a size T3 less than the dimension of the free space in the memory subspace Z1. It is therefore created in the memory subspace Z1 with the address AdRN+T1+1 as its reference address.

Thus, at two different sessions, for the same type of session, the reference addresses of the same object are different, and this in a random or pseudorandom manner since, for each of them, the number N will be different. As a result attacks based on the repetition of the same operation become ineffective since they cannot be correlated with each other. Moreover, this result is achieved without over-consumption of memory space. This is because it will be noted that the size of the memory space used by the three objects O1, O2 and O3, in FIG. 3, is the same as that used by the same objects without the partitioning of the space Z into two subspaces Z1 and Z2 as described below.

FIG. 4 shows a flow diagram of a method for managing memory resources according to the invention. This method is implemented following the launch of a session, for example by introducing the card concerned into a suitable reader.

Step E1 is a step of formatting a memory space Z, for example in RAM or EEPROM memory, allocated to the session that has just been launched for storing computer objects that will be created during this session.

Step 2 is a step of partitioning the allocated memory space Z into a first memory subspace Z1 and a second memory subspace Z2, as disclosed above in relation to FIG. 3

Steps E3, E4 and E5 are steps of allocating memory blocks respectively to three computer objects being created, and this as disclosed above in relation to FIG. 3.

Other objects can be created in this way, just as some can be deleted in order to release memory space. At the end of this session, the implementation of the method is interrupted.

1. Method for managing memory resources of a security device, such as a chip card, of the type comprising:
a step of formatting a memory space allocated to a session for storing computer objects, and
carried out whenever a computer object is created, a step of allocating a memory block in said memory space storing said computer object being created,
characterised in that it further comprises:
a step of partitioning the memory space allocated to a session into in one side a first memory subspace the first address of which is determined according to a random or pseudorandom number and the last address of which is the last address of said allocated memory space, and in another side a second memory subspace the first address of which is the first address of said allocated memory space and the last address of which is the address preceding the first address of said first subspace,
and in that the step of allocating a memory block comprises a step of seeking an allocatable memory block first performed in said first memory subspace and then if necessary in said second memory subspace.

2. Security device, such as a chip card, comprising a processing unit provided with an operating system and a memory, characterised in that said operating system is designed so as to be able to implement the management method according to claim 1.

3. Program implemented on a memory medium of a security device, such as a chip card, which comprises a processing unit provided with an operating system and a memory, said program being able to be carried out by said operating system and comprising instructions for carrying out a management method according to claim 1.
